(19) United States
(12) Patent Application Publication
(10) Pub. No.: US 2026/0065454 A1
(43) Pub. Date: Mar. 5, 2026

(54) Method and Device for Portable, Modular and Compact Optical Microscopy for Studying Material Dynamics at the Nanoscale

(71) Applicant: Universities Space Research Association, Columbia, MD (US)

(72) Inventors: Suman Sinha-Ray, Cleveland, OH (US); Amine Missaoui, Cleveland, OH (US); Jack Qiao, Cleveland, OH (US)

(21) Appl. No.: 19/314,320

(22) Filed: Aug. 29, 2025

Related U.S. Application Data
(60) Provisional application No. 63/688,515, filed on Aug. 29, 2024.

(51) Int. Cl. G06T 7/00; G01N 15/1429; G02B 21/36; G06T 7/60

(52) U.S. Cl. CPC G06T 7/0002; G01N 15/1429; G02B 21/361; G02B 21/365; G06T 7/60; G06T 2207/10016; G06T 2207/10056; G06T 2207/20224

(57) ABSTRACT

A set of compact microscopes, one of which works as an attachment to a camera-equipped cell phone, that can fit in a 3 U CubeSat and be used as a platform for high-resolution optical microscopy and characterization of nanoscale dynamics. An advanced software package, which can be deployed via a mobile interface, enabling users to reliably capture image sequences of moving particles with their smartphone cameras, and enabling immediate access to precise rheological results.

### FIELD OF THE INVENTION

This invention relates to differential dynamic microscopy and devices.

### SUMMARY OF THE INVENTION

Optical microscopy is a fundamental tool of modern technology, playing an essential function in many fields, notably in healthcare and space research. Thanks to the advances in imaging capabilities of the light microscope, researchers can now explore problematic structures in biological samples, facilitating the prognosis of diseases at the mobile stage and enabling them to gain a deeper understanding of cellular structures and functions. From the identification of cancer cells to the discovery of microbial pathogens, light microscopy provides invaluable information, essential to the development of effective therapeutic strategies. Unfortunately, due to the relatively expensive cost of optical microscopes and of the equipment required to perform advanced imaging, they are still out of reach, particularly in rural and developing areas. Recently, numerous groups have successfully developed compact microscopy systems capable of reproducing accurate results comparable to those of conventional microscopes. These systems can provide a reliable, easy-to-implement and scalable solution for students and early-stage researchers, as well as for a wide range of microscopic imaging needs.

The importance of equipment size in space studies cannot be overstated, as it has a direct impact on feasibility, functionality and cost. The miniaturization of devices plays a key role in enabling spacecraft to perform complex tasks efficiently within strict weight limits. Smaller equipment reduces payload mass, thereby reducing launch costs and increasing mission possibilities. In addition, compact devices often have lower power requirements, resulting in reduced energy consumption and extended operational life. Conversely, building and launching large-scale gadgets entails exorbitant costs, due to the need for specialized manufacturing strategies, transportation logistics and extensive testing. Consequently, the costs associated with the development and deployment of bulky equipment underline the vital importance of time optimization in research efforts, focusing on the important balance between functionality, cost-effectiveness and mission objectives.

Differential dynamic microscopy (DDM) is an emerging imaging technique rapidly evolving in the field of imaging microscopy research. The technique represents an alternative to more conventional techniques such as dynamic light scattering (DLS) or video particle tracking (VPT). It uses the conventional basis of the bright-field optical microscope to provide access to wave-vector-dependent relaxation times from real-space images. It was first introduced by Cerbino and Trappe in 2008 and since it's been used by researchers in diverse experiments including the study of active motion of protein inside cells, the kinetics of colloidal fractal aggregation, the dynamics of E. coli bacteria and their swimming speed distribution, the structure and dynamics of concentration fluctuations in a non-equilibrium dense colloidal suspension, and the dynamics of nematic liquid crystals and gold nanoparticles. Since Cerbino and Trappe used DDM to study the Brownian motion of 73 nm particles in colloidal suspensions, different microscopy approaches have adopted the differential dynamic microscopy techniques, such as confocal, fluorescence-based, dark-field and polarized, to study diverse systems.

In this work, we have extended the capabilities of DDM, notably its size, to suit advanced research and overcome challenges such as the environmental limited resources (e.g., Artemis, ISS, Cube sat, etc.). We have developed a set of compact microscopes, one of which works as an attachment to a camera-equipped cell phone, that can fit in a 3 U CubeSat and be used as a platform for high-resolution optical microscopy and characterization of nanoscale dynamics. We have developed an advanced home-built software package, which we have deployed via a mobile interface, enabling users to reliably capture image sequences of moving particles with their smartphone cameras, and enabling immediate access to precise rheological results.

Accordingly, there is provided according to the invention a modular portable device for differential dynamic microscopy having:
a sample holder with an adjustable stage configured to position and maintain a sample containing particles in suspension;
an objective lens positioned to collect light scattered by the particles in the sample;
a lens-to-camera adapter configured to couple the objective lens to a high-speed imaging device;
a high-speed camera operatively connected to the lens-to-camera adapter, wherein the camera is configured to capture sequential images at a frame rate sufficient to resolve characteristic time scales of particle dynamics in the sample;
a processing unit having at least one processor, wherein the processing unit is either:
   connected to the high-speed camera via wired or wireless connection, or
   integrated with the high-speed camera as a single unit (including smartphone implementations); and
a computer readable memory containing computer readable instructions, which when executed by the processor perform the following operations:
   control the high-speed camera to acquire a time series of images of the sample at predetermined time intervals;
   perform image subtraction between pairs of images separated by different time lag intervals;
   convert the subtracted images to Fourier domain representations;
   calculate power spectrum variations as a function of different lag times from the Fourier domain representations; and
   determine dynamic properties of particles in the sample from the power spectrum variation data.

According to a modular option for the invention, the device may allow for interchangeable components including different objective lenses, camera adapters, and processing units to accommodate various sample types and measurement requirements.

According to portable embodiments of the invention the device may be configured as a portable system with components sized and arranged for field deployment and operation outside of traditional laboratory settings.

According to a Smartphone embodiment the device may be a smartphone that includes both the camera and processor, and wherein the computer readable instructions are implemented as a mobile application.

According to enhanced processing embodiments of the invention the computer readable instructions may further include one or more of the following:
Q-space coordinate calculation for spatial frequency analysis;
radial averaging of power spectrum data;
multi-component exponential fitting algorithms; and
real-time progress tracking and visualization of analysis results.

Each of the aforementioned embodiments and options may be combined with one or more of the other aforementioned embodiments and options

There is further provided according to the invention a method for performing differential dynamic microscopy using a modular portable device, the method including the steps:
positioning a sample containing particles in suspension on an adjustable stage of a sample holder;
directing light through an objective lens to illuminate the sample and collect scattered light;
coupling the objective lens to a high-speed camera through a lens-to-camera adapter;
acquiring sequential images of the sample using the high-speed camera at a frame rate faster than characteristic time scales of particle motion in the sample;
processing the acquired images using a processing unit by:
   performing image subtraction between image pairs separated by different time lag intervals;
   converting the subtracted images to Fourier domain representations using fast Fourier transform algorithms;
   calculating power spectrum variations as a function of time lag from the Fourier domain data;
   extracting dynamic information about particles in the sample from the power spectrum variation data.

According to an enhanced analysis embodiment, the method may further include the steps of:
calculating q-space coordinates corresponding to spatial frequencies in the Fourier domain;
performing radial averaging of the power spectrum data;
applying multi-component fitting algorithms to determine size distributions and diffusion constants of particles; and
generating real-time visualization of analysis progress and results.

In an adaptive processing embodiment of the method, the processing may adapt to available computational resources by:
automatically selecting between CPU and GPU acceleration based on hardware availability;
optimizing memory usage for processing large image datasets; and/or
implementing parallel processing techniques to reduce analysis time.

According to a mobile implementation of the method in which the method is carried out on a Smartphone, the method may include the steps of:
executing the image processing algorithms through a mobile application;
utilizing the smartphone's built-in camera as the high-speed imaging device; and/or
storing and displaying results on the smartphone's memory and display systems.

According to a quality control embodiment of the method according to the invention, the steps may include:
monitoring image quality metrics during acquisition;
automatically adjusting imaging parameters based on sample characteristics;
implementing error detection and correction algorithms to ensure measurement reliability; and/or
providing user feedback on measurement quality and suggested improvements.

Each of the aforementioned optional method embodiments may be combined with one or more of the other aforementioned method embodiments and/or with each of the above-described device embodiments.

It is specifically noted that every combination and sub-combination of the above-listed and below-described features and embodiments is considered to be part of the invention.

### BRIEF DESCRIPTION OF DRAWINGS

The foregoing summary, as well as the following detailed description of the preferred invention, will be better understood when read in conjunction with the appended drawings. For the purposes of illustrating the invention, there are shown in the drawings embodiments which are presently preferred. It should be understood, however, that the invention is not limited to the precise arrangements and instrumentalities shown. In the drawings:

FIG. 1 shows a mobile phone microscopy layout (not to scale) for DDM imaging. The light source is a high-power white LED chip. The objective and eyepiece are mounted together on an optical tube allowing adjustment for magnification change. Bright field microscopy images of a 1 μm polystyrene spherical particles sample are shown, taken with (a) Commercial Leica microscope (b) Home-built microscope (c) Compact phone-microscope. The white bar represents 30 μm. (d) Commercial Leica microscope. (e) Intermediate compact setup. (f) Current prototype of the mobile phone microscopy. The light source is not visible because it is contained within the sample holder (black box). The objective is mounted within the optical tubing that is rotated to change the focusing.

FIG. 2 is a representation of a differential dynamic microscopy process according to an embodiment of the invention.

FIG. 3 shows the differential Intensity Correlation Function, D (q, Δt), as a function of the lag-time Δt in loglog scale obtained using the Leica standard microscope (a), home-built compact microscope (b) and mobile phone microscopy (c), respectively. Colors represent the wave vector q value. Lines are for eye guidance

FIG. 4 shows particle diffusion coefficient as a function of the particle size for a Leica standard microscope (a), home-built compact microscope (b) and mobile phone microscopy (c). Black and red data points are experimental and theoretical results respectively. Lines are for eye guidance.

### DETAILED DESCRIPTION OF THE INVENTION

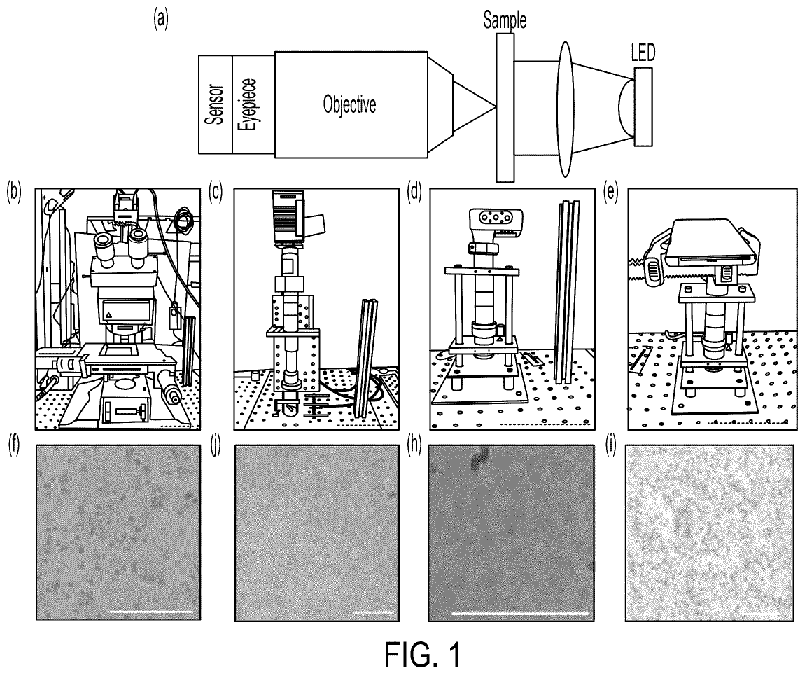

In order to evaluate the capabilities of the compact systems we have developed during our work, we first carried out experiments to capture the Brownian motion of colloidal suspensions on an unmodified Leica DMRXA commercial microscope. This standard instrument was equipped with an achromatic ×20 objective with a numerical aperture NA=0.4. Samples were illuminated by focusing a white halogen light source on the sample's mid-plane using a condenser of NA=1.25. A high-speed camera (Phantom C210) was used for data acquisition. with pixel sizes of 0.1 to 0.4 μm. Samples consisted of glass capillary tubes filled with a solution of polystyrene microspheres (density of polystyrene, [symbol] =1040 kg·m⁻³), with radii ranging from 50 nm to 2 μm and a polydispersity of 10% (Alfa Aesar from ThermoFisher Scientific). Particles were dispersed in deionized water (at room temperature, T=23 C, the water viscosity and density are, respectively, η=0.996 mPa·s and [symbol] =1000 Kg·m⁻³). The particle concentration was 0.01% by weight fraction, which is low enough to neglect the effect of particle interaction. The refractive index of polystyrene is ≈1.6, which is higher than that of water ≈1.3. Due to this mismatch, the particles are visible in brightfield microscopy images (see FIG. 1). The glass capillary tube was bonded to a transparent microscope slide using a fast-drying epoxy resin to prevent solvent evaporation. The inner thickness of the capillary tube along the optical axis of the microscope is 0.4 mm. Data were acquired in a region at the center of the capillary tube to minimize edge effects on particle dynamics.

Our first compact system consists of a home-built microscope, as shown in FIG. 1e. This device uses similar equipment to the Leica microscope described above, i.e., an achromatic objective (magnification ×20, numerical aperture NA=0.4), a white halogen lamp for illumination and a high-speed Phantom camera for data acquisition. This system uses a similar condenser with NA=1.25 to focus the light on the sample's mid-plane. We have designed this system as an alternative to the large standard Leica microscope, with the aim of testing a simpler and compact system to reproduce the results of a commercial microscope.

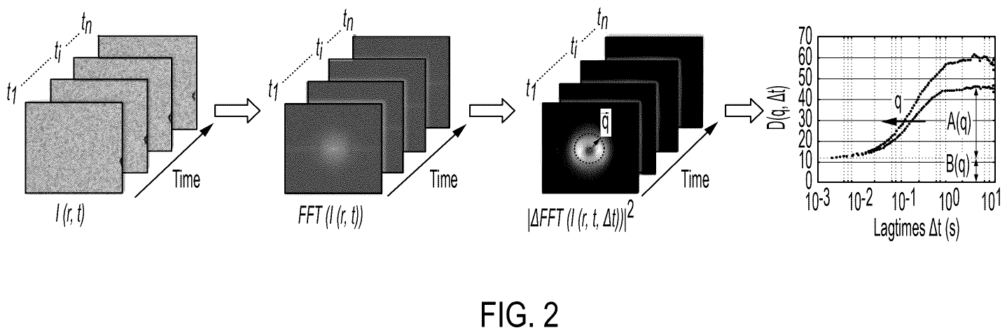

Our second system consists of a more compact, home-built brightfield optical microscope designed to be attached to a camera-equipped cell phone (FIG. 1f). This device uses an inexpensive, high-power white LED as a light source. The use of this type of illumination suits our portable system as it is commercially available at low cost and in a wide range of emission wavelengths, which is important for other applications, such as fluorescence imaging. This type of illumination is robust to mechanical shock, operates with low power consumption and has a long lifetime, unlike the large standard illumination sources used in commercial microscopes. This configuration does not require a light condenser, instead we have used a collecting lens placed in front of the LED chip (see FIG. 2). With this setup, we used a ×10 Cf finite conjugation microscope objective with a numerical aperture NA=0.17 and a ×10 magnification eyepiece (from Edmund Optics). The system optical magnification can be adjusted between ×10 and ×20 simply by changing the distance between objective and eyepiece, resulting in a resolution per pixel ranging between 0.8 μm and 0.4 μm. Due to aberrations, field curvature and imperfections in the smartphone camera lens, the optical resolution is reduced outside the best-focus radius. Thus, data images are cropped at the center before analysis.

For data acquisition with this portable setup, we used an iPhone 14 Pro Max (from Apple), equipped with a 12 MP 1/1.28″ sensor with a Quad-Bayer color filter. The smartphone camera has a 1.4 μm pixel size and 13 mm focal length. The phone and optical parts were mounted on a 3D printed box guaranteeing the good alignment of the different component and allows for change the objective focus easily. Brightfield images were recorded using the default camera settings and slow-motion mode, with a frame rate ranging between 160-190 image per second (fps). A total number of image N=5000 was recorded with a disabled flashlight.

To capture the Brownian motion of colloidal suspensions, we used the microscopic scattering technique known as differential dynamics microscopy (DDM). It uses the conventional basis of the bright-field optical microscope to provide access to wave-vector-dependent relaxation times from real-space images. Particle diffusion coefficient can be obtained by time analysis of spatial Fourier transforms of real-space images using a home-built Python-based program. Briefly, if one consider the intensity distribution of a two-dimensional 2D image at a given time t as I(x, y; t) and Δt as I(x, y; Δt), one can define the difference image signal for each pair of image present in the data sequence as ΔI(x, y; Δt)=I(x, y; Δt)−I(x, y; t).

In the case of isotropic samples, like the ones investigated during our work, the differential intensity correlation function (DICF), D(q; Δt)= [symbol] |ΔI(q; Δt)|2 [symbol] , where [symbol] |ΔI(q; Δt)|² [symbol] is the 2D Fourier transform of ΔI(x, y; Δt). For Brownian motion, it is well known that every Fourier concentration mode decays exponentially in time, exp (−Δt/τ(q)), with a wave-vector dependent relaxation characteristic time τ(q)=1/Dₘq², where Dₘ is the mass diffusion coefficient of the particles and predicted by Stokes-Einstein's equation:

$${D}_{m} = {K}_{B} T / 3 π η d \qquad ( 1 )$$

Here, K_{B} is the Boltzmann constant, T is the absolute temperature, η is the solvent viscosity, d and is the particle diameter. For the analysis of the difference images, it's been shown that:

$$D ( q ; Δ t ) = A ( q ) [ 1 - exp ( - Δ t / τ ( q ) ] + B ( q ) . \qquad ( 2 )$$

In the previous equation, the term A(q) is a static amplitude term that depends on the contrast mechanism behind the image formation and on the distribution and shape of elementary objects. The term B(q) accounts for the camera noise and is present even in the absence of the particles. One can see now that the statistical analysis of the intensity differences as a function of time provides information on particle diffusion.

One major downside of the DDM technique is the time required for the code to process all images, analyze and extract the required information. Typically, this time is of the order of 120 minutes for a data sequence of around 5000 images and a resolution of 640×640 pixels. In our code, we have implemented two methods to reduce this processing time. The first method is data down-sampling, which consists of considering only a few percentages of the total images number, to be then equally distributed over the entire data sequence. The second method involves cropping the original full images to a smaller size, but sufficiently large to have enough particles visible in the field of view. Implementing these two methods reduced considerably the computation time. We found that analyzing only 2% of the total number of images and considering only 25% of the total image size reduced the computation time from 120 minutes to 3 minutes, which was enough to achieve satisfactory results. These findings are presented below.

FIG. 1 shows microscopic images of a colloidal dispersion of 350 nm diameter particles acquired using the three different microscopic configurations described above. The small dark spots visible in the images are the colloidal particles while the large asymmetrical objects are dust particles present in the optical path, that will not contribute to the image analysis as they will be removed during the substruction process in the DDM code as they do not move. To compare the results of the three setups, we measured the diffusion coefficient of particle samples with sizes ranging from 1 μm to 50 nm. During our experiments, we used a sequence of N=5000 images acquired at frame rates varying between 120-240 fps, from which we only considered 2%, i.e., 100 images evenly distributed, so the first image is for N=0 and the last image is for N=5000. Before analyzing the data with the DDM code, we cropped the images from 640×640 pixels to 128×128 pixels from the center. This dimension is sufficient to have a large enough number of particles to quantify the Brownian motion. We then calculated the differential intensity correlation function (DICF) and fitted the data with Eq. (2).

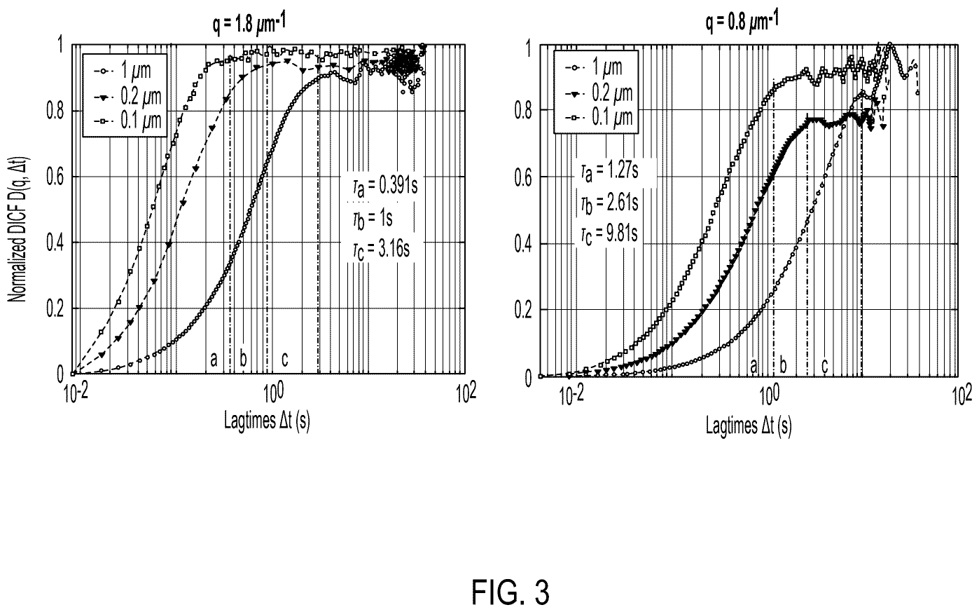

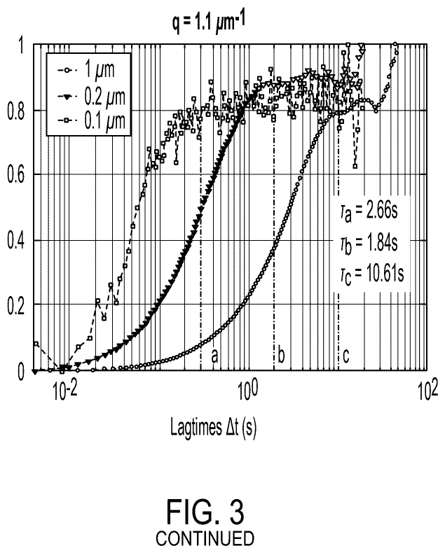

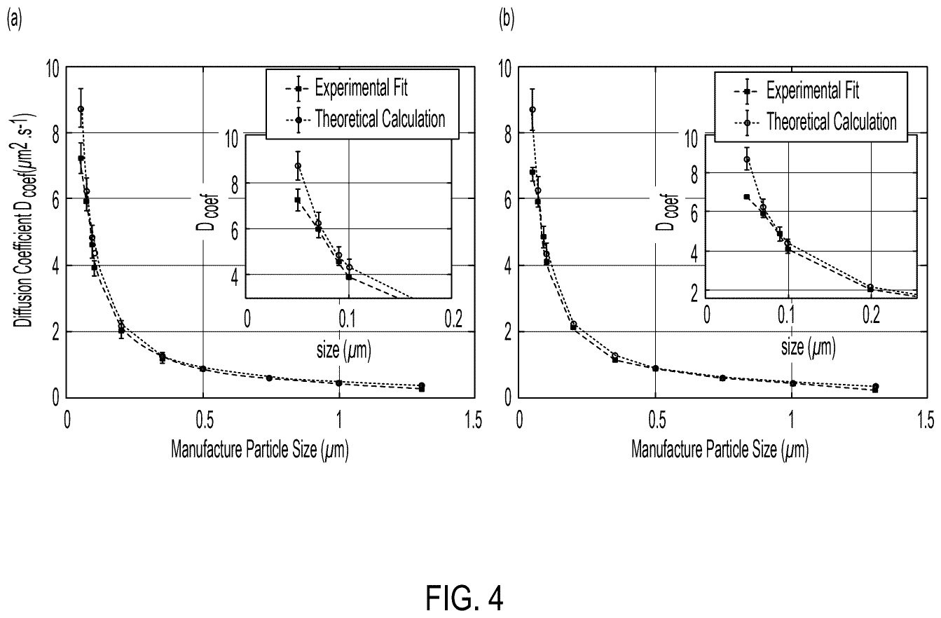

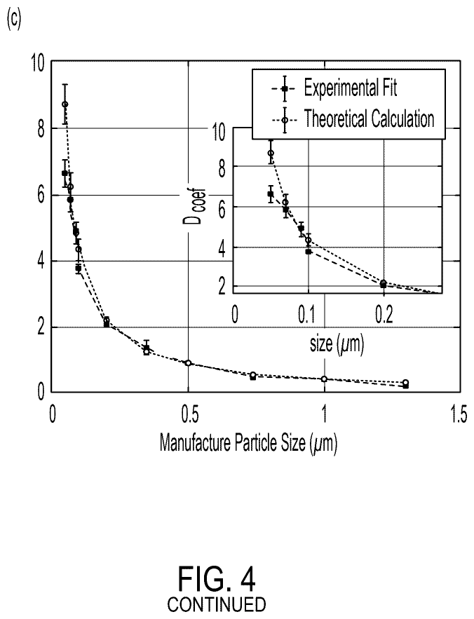

FIG. 3 shows the DICF, D(q, Δt), as a function of the lag-time Δt, of the samples shown in FIG. 1, for values of the wave vector q ranging between 1.18 μm⁻¹ and 9.1 μm⁻¹. For a fixed q, we treat A(q) and B(q) as simple fitting parameters and extract the characteristic time τ(q) by simply considering the Δt dependence of D(q; Δt). The diffusion coefficient, Dₘ, can then be calculated using the formula τ(q)=1/Dₘq². The results obtained for different particle sizes and with different setups are shown in FIG. 4. The black data points represent the analytically calculated estimate of the diffusion coefficient using Stokes-Einstein's equation (Eq. 2). The error bars consider the 10% polydispersity in particle size from the manufacture. The blue and red data points represent the experimental data obtained using two fitting methods that will be discussed below. With the exception of large particles, larger than 1 micron, which tend to aggregate, it is clear from the good agreement between the experimental and theoretical results that Brownian motion of the colloidal suspensions can be estimated accurately using the different setup. However, closer inspection of the figures would reveal that for small sizes, i.e., 50 nm and below, standard methods of estimating the Brownian motion of colloidal suspensions do not provide sufficiently accurate results.

It is well known that particles of small size relative to the wavelength of the incident light, such as nanoparticles, exhibit a weak light-scattering signal. They interact differently with light than larger particles. Due to their small size, the scattering cross-section decreases considerably, resulting in light scattered in a more forward direction and weaker signals in opposite directions, allowing less scattered light to be detected. The weak signals make it challenging to detect and analyze the presence of these particles using conventional scattering techniques. These complications manifest in our experiments through the differential intensity correlation function data.

To overcome this challenge, one would avoid fitting areas with these significant noise levels. To do so, one could rewrite equation 2, in the case of small lag-time Δt as the following:

$$D ( q ; Δ t ) = [ A ( q ) / τ ( q ) ) ] \times Δ t + B ( q ) . \qquad ( 3 )$$

With equation 3, one could fit the rising linear part of the DICF for small Δt. Using this method, B(q) is determined as the value at the origin, while A(q) is determined from fitting the full DICF at large lag-time Δt. The characteristic time τ(q) is then determined from the slope as shown in Eq 3. Results of the diffusion coefficient for different particles are shown in table 1 and FIG. 4 by the green data points. It is clear that this new fitting method successfully estimates the diffusion coefficient of our particles. The new approach not only produces more accurate results for small particles, but also reduces computation time, since only a few data points are needed for both short and long lag-times, and only a few values of the wave vector q are required.

TABLE 1

| Manufacture | Measured size (mm) | | |
|---|---|---|---|
| size (mm) | Leica | Compact | Phone |
| 0.05 ± 0.005 | 0.06 ± 0.004 | 0.064 ± 0.003 | 0.065 ± 0.003 |
| 0.07 ± 0.007 | 0.073 ± 0.004 | 0.074 ± 0.002 | 0.075 ± 0.005 |
| 0.09 ± 0.009 | 0.095 ± 0.003 | 0.089 ± 0.005 | 0.089 ± 0.006 |
| 0.10 ± 0.01 | 0.11 ± 0.006 | 0.10 ± 0.003 | 0.12 ± 0.07 |
| 0.20 ± 0.02 | 0.21 ± 0.028 | 0.21 ± 0.003 | 0.21 ± 0.014 |
| 0.35 ± 0.035 | 0.37 ± 0.04 | 0.38 ± 0.005 | 0.32 ± 0.025 |
| 0.50 ± 0.05 | 0.53 ± 0.062 | 0.51 ± 0.01 | 0.49 ± 0.034 |
| 0.74 ± 0.074 | 0.74 ± 0.069 | 0.74 ± 0.02 | 0.85 ± 0.054 |
| 1.00 ± 0.1 | 1.08 ± 0.027 | 1.05 ± 0.12 | 1.03 ± 0.07 |
| 1.40 ± 0.14 | 1.68 ± 0.12 | 1.78 ± 0.10 | 1.84 ± 0.09 |

We have developed a set of portable, modular and compact optical microscopy instruments to study material dynamics at the nanoscale. A 3D printable platform for differential dynamic microscopy experiments, with analysis software, has been developed. The systems provide accurate and reliable measurements of colloidal particle dynamics. A high-power white LED coupled to a collecting lens has been successfully used as a light source for the differential dynamic microscopy. These off-the-shelf and inexpensive LEDs are proving reliable for studying the dynamics of nanoscale materials despite their low degree of temporal coherence. A smartphone was used for data acquisition using its high-speed camera and data analysis using the integrated mobile app. By deploying a home built DDM code, we successfully imaged and characterized the diffusion coefficient of particles, with diameters ranging from 50 nm to 1 micron. Reducing the analyzed data to just 2% and cropping the images to a small size were sufficient to obtain accurate measurements. Such a small data size reduces computation time and enables an almost instantaneous result to be obtained. The new fitting approach produces more accurate results for small particles and reduces even more the computation time, since only a few data points are needed for both short and long lag-times, and only a few values of the wave vector q are required.

Our results not only demonstrates that DDM technique is a powerful tool for monitoring the dynamics of particles, that can either be resolved individually or not, but also demonstrate the reliability of the compact setup.

The differential dynamic microscopy configuration presented in our work can serve as a reliable, compact, easy-to-implement and affordable solution for space research, as it can fit into a 3 U CubeSat. The total estimated cost for the 3D-printed configuration is $820 ($720 Cf finite conjugation microscope objective, $84 eyepiece, $5 3D printing, $10 power bank), which significantly reduces the cost of space research. Future developments could extend the capabilities of the compact DDM to the study of complex fluids and moving biological systems. In this context, our compact DDM offers many more possibilities than dynamic light scattering and can be used in a variety of contexts.

Notwithstanding the specific embodiments, features, elements, combinations and sub-combinations disclosed herein, it is expressly considered and here-disclosed that every single element, every single feature, and every combination and sub-combination thereof disclosed herein may be combined with every other element, feature, combination and sub-combination disclosed herein.

It will be appreciated by those skilled in the art that changes could be made to the embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification.

1. A modular portable device for differential dynamic microscopy comprising:
a sample holder with an adjustable stage configured to position and maintain a sample containing particles in suspension;
an objective lens positioned to collect light scattered by the particles in the sample;
a lens-to-camera adapter configured to couple the objective lens to a high-speed imaging device;
a high-speed camera operatively connected to the lens-to-camera adapter, wherein the camera is configured to capture sequential images at a frame rate sufficient to resolve characteristic time scales of particle dynamics in the sample;
a processing unit comprising at least one processor, wherein the processing unit is either:
connected to the high-speed camera via wired or wireless connection, or
integrated with the high-speed camera as a single unit (including smartphone implementations); and
a computer readable memory containing computer readable instructions, which when executed by the processor perform the following operations:
control the high-speed camera to acquire a time series of images of the sample at predetermined time intervals;
perform image subtraction between pairs of images separated by different time lag intervals;
convert the subtracted images to Fourier domain representations;
calculate power spectrum variations as a function of different lag times from the Fourier domain representations; and
determine dynamic properties of particles in the sample from the power spectrum variation data.

2. The device of claim 1, wherein the modular configuration allows for interchangeable components including different objective lenses, camera adapters, and processing units to accommodate various sample types and measurement requirements.

3. The device of claim 1, wherein the device is configured as a portable system with components sized and arranged for field deployment and operation outside of traditional laboratory settings.

4. The device of claim 1, wherein the processing unit comprises a smartphone device that includes both the camera and processor, and wherein the computer readable instructions are implemented as a mobile application.

5. The device of claim 1, wherein the computer readable instructions further comprise one or more of:
Q-space coordinate calculation for spatial frequency analysis;
radial averaging of power spectrum data;
multi-component exponential fitting algorithms; and
real-time progress tracking and visualization of analysis results.

6. A method for performing differential dynamic microscopy using a modular portable device, the method comprising:
Positioning a sample containing particles in suspension on an adjustable stage of a sample holder;
Directing light through an objective lens to illuminate the sample and collect scattered light;
Coupling the objective lens to a high-speed camera through a lens-to-camera adapter;
Acquiring sequential images of the sample using the high-speed camera at a frame rate faster than characteristic time scales of particle motion in the sample;
Processing the acquired images using a processing unit by:
performing image subtraction between image pairs separated by different time lag intervals;
converting the subtracted images to Fourier domain representations using fast Fourier transform algorithms;
calculating power spectrum variations as a function of time lag from the Fourier domain data;
extracting dynamic information about particles in the sample from the power spectrum variation data.

7. The method of claim 6, further comprising:
calculating q-space coordinates corresponding to spatial frequencies in the Fourier domain;
performing radial averaging of the power spectrum data;
applying multi-component fitting algorithms to determine size distributions and diffusion constants of particles; and
generating real-time visualization of analysis progress and results.

8. The method of claim 6, wherein the processing adapts to available computational resources by:
automatically selecting between CPU and GPU acceleration based on hardware availability;
optimizing memory usage for processing large image datasets; and
implementing parallel processing techniques to reduce analysis time.

9. The method of claim 6, wherein the method is performed using a smartphone-based implementation, and further comprising:
executing the image processing algorithms through a mobile application;
utilizing the smartphone's built-in camera as the high-speed imaging device; and
storing and displaying results on the smartphone's memory and display systems.

10. The method of claim 6, further comprising:
monitoring image quality metrics during acquisition;
automatically adjusting imaging parameters based on sample characteristics;
implementing error detection and correction algorithms to ensure measurement reliability; and
providing user feedback on measurement quality and suggested improvements.
